(19) United States
(12) Patent Application Publication
(10) Pub. No.: US 2016/0257105 A1
(43) Pub. Date: Sep. 8, 2016

(54) Decal Removal Assembly

(71) Applicants: Craig Thompson, Aurora, CO (US); Pamela Thompson, Aurora, CO (US)

(72) Inventors: Craig Thompson, Aurora, CO (US); Pamela Thompson, Aurora, CO (US)

(21) Appl. No.: 14/640,248

(22) Filed: Mar. 6, 2015

(51) Int. Cl. B32B 38/10; B32B 43/00

(52) U.S. Cl. CPC B32B 38/10; B32B 43/006

(57) ABSTRACT

A decal removal assembly includes a plate that is structured to have a steam space extending therein. The plate may be positioned proximate a surface such that the steam space surrounds a decal adhered to the surface. A handle is attached to the plate and the handle is in fluid communication with the steam space. A nozzle is attached to the handle and the nozzle has a distal end with respect to the handle. The nozzle is in fluid communication with the steam space and the distal end may be fluidly coupled to a steam source. Steam from the steam source is directed into the steam space thereby facilitating removal of the decal from the surface. A plurality of couplers is provided and each of the couplers is attached to the plate. Each of the couplers engages the surface such that the plate is retained on the surface and each of the couplers is positioned proximate one of four corners of the plate.

### BACKGROUND OF THE DISCLOSURE

### Field of the Disclosure

The disclosure relates to decal removal devices and more particularly pertains to a new decal removal device for using steam to remove a decal from a surface.

SUMMARY OF THE DISCLOSURE

An embodiment of the disclosure meets the needs presented above by generally comprising a plate that is structured to have a steam space extending therein. The plate may be positioned proximate a surface such that the steam space surrounds a decal adhered to the surface. A handle is attached to the plate and the handle is in fluid communication with the steam space. A nozzle is attached to the handle and the nozzle has a distal end with respect to the handle. The nozzle is in fluid communication with the steam space and the distal end may be fluidly coupled to a steam source. Steam from the steam source is directed into the steam space thereby facilitating removal of the decal from the surface. A plurality of couplers is provided and each of the couplers is attached to the plate. Each of the couplers engages the surface such that the plate is retained on the surface and each of the couplers is positioned proximate one of four corners of the plate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a decal removal assembly according to an embodiment of the disclosure.

FIG. 2 is a bottom view of an embodiment of the disclosure.

FIG. 3 is a bottom perspective view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### DESCRIPTION OF THE PREFERRED EMBODIMENT

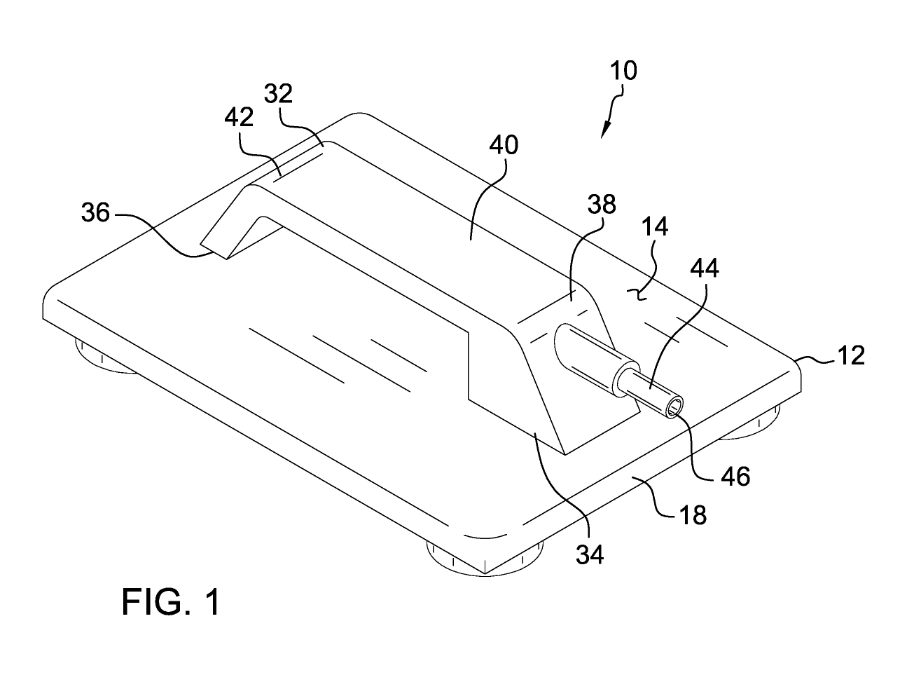

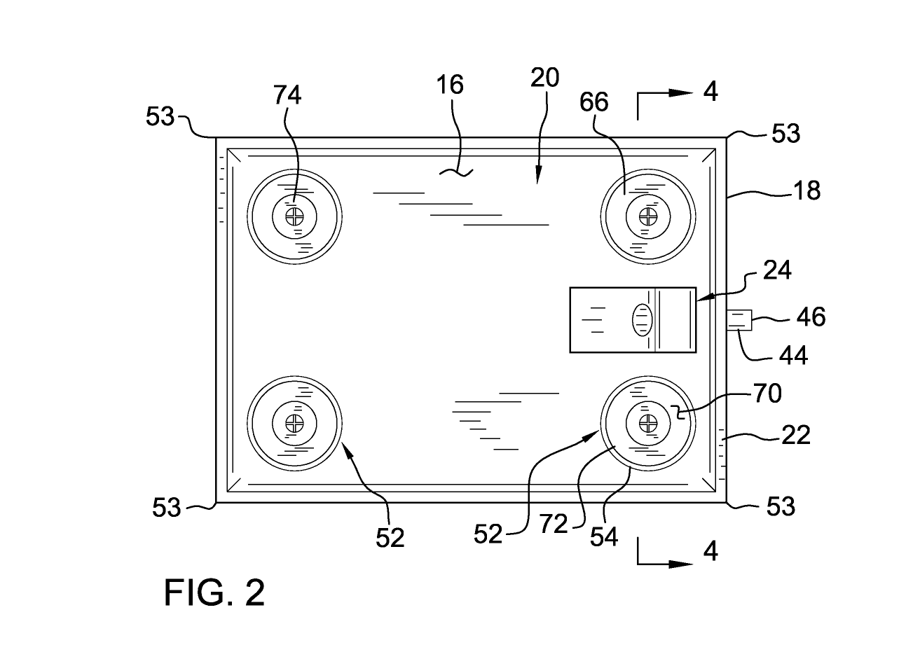

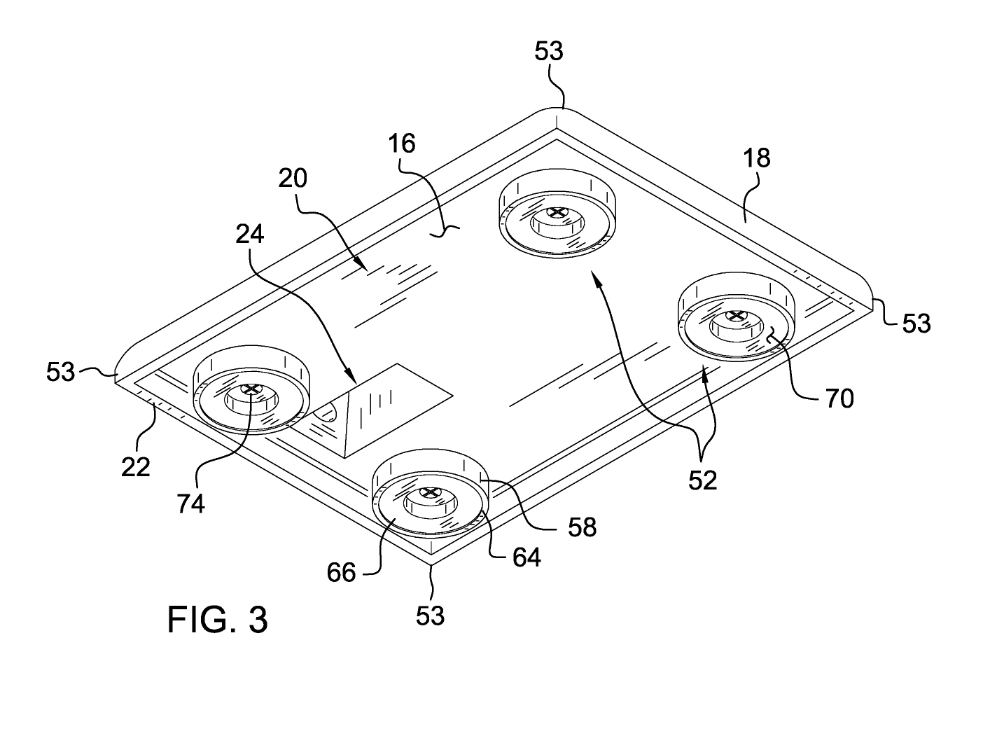

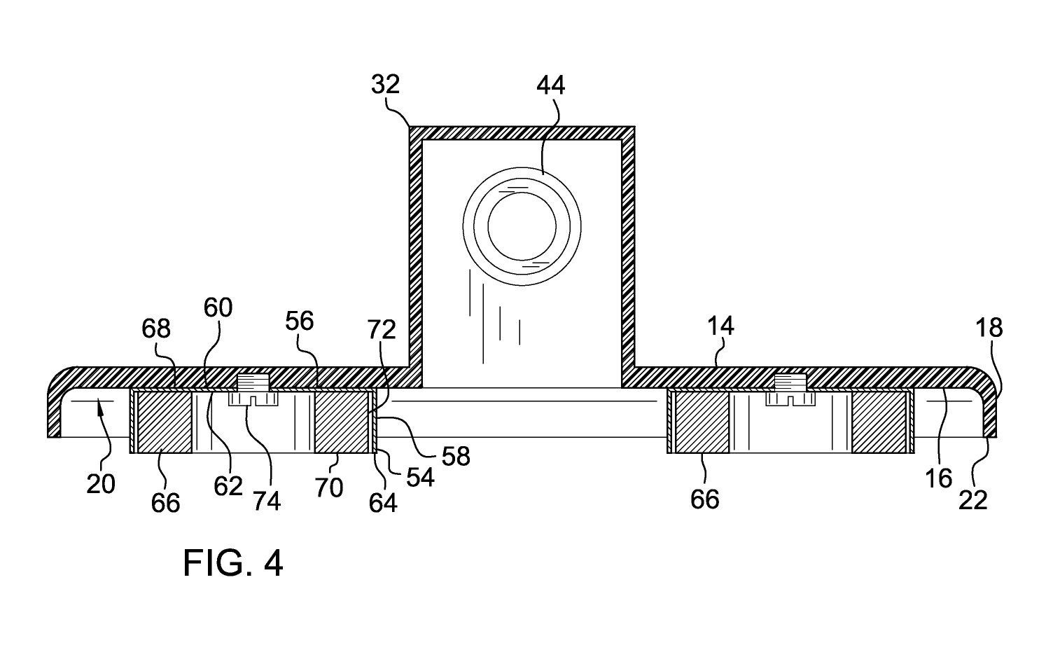

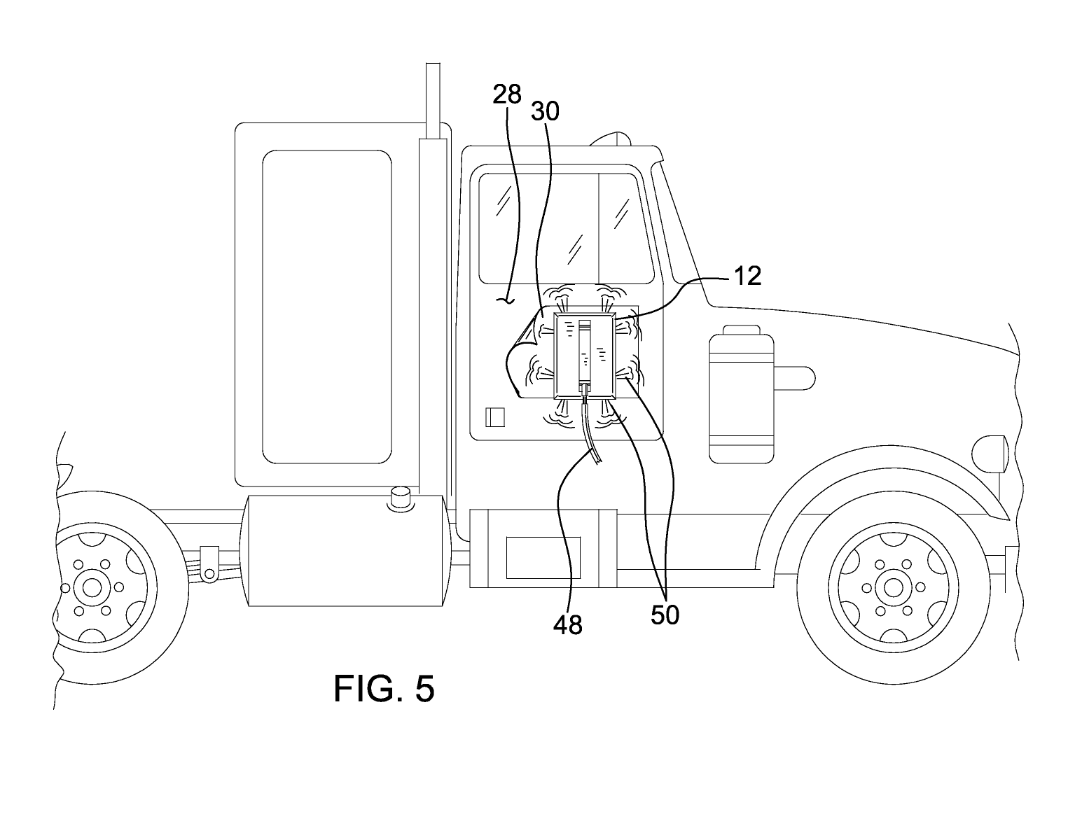

With reference now to the drawings, and in particular to FIGS. 1 through 5 thereof, a new decal removal device embodying the principles and concepts of an embodiment of the disclosure and generally designated by the reference numeral 10 will be described.

As best illustrated in FIGS. 1 through 5, the decal removal assembly 10 generally comprises a plate 12 that has a top surface 14, a bottom surface 16 and a peripheral wall 18 extending around the plate 12 and the peripheral wall 18 extends outwardly beyond the bottom surface 16 to define a steam space 20. The peripheral wall 18 has a distal edge 22 with respect to the bottom surface 16 and the plate 12 has an opening 24 extending through the top surface 14 and the bottom surface 16. The peripheral wall 18 has a first side 26 and the opening 24 is positioned proximate the first side 26. The distal edge 22 may be positioned proximate a surface 28 such that the steam space 20 surrounds a decal 30 adhered to the surface 28. The surface 28 may be a door of a vehicle or the like that is magnetically attractive. The decal 30 may be a decal of any conventional design utilizing an adhesive to adhere to the surface 28.

A handle 32 is attached to the plate 12 and the handle 32 has a first end 34 and a second end 36. The handle 32 has a first bend 38 positioned adjacent to the first end 34 such that the first end 34 is directed downwardly from a body 40 of the handle 32. Additionally, the handle 32 has a second bend 42 positioned adjacent to the second end 36 such that the second end 36 is directed downwardly from the body 40 of the handle 32.

The first end 34 is open and the handle 32 is substantially hollow. Each of the first end 34 and the second end 36 is attached to the top surface 14 and the first end 34 is aligned with the opening 24 in the plate 12 such that the handle 32 is in fluid communication with the steam space 20.

A nozzle 44 is attached to the handle 32 and the nozzle 44 has a distal end 46 with respect to the handle 32. The nozzle 44 may be positioned proximate the first bend and he nozzle 44 is in fluid communication with the steam space 20 and the distal end 46 may be fluidly coupled to a steam source 48. Steam 50 from the steam source 48 is directed into the steam space 20 thereby facilitating removal of the decal 30 from the surface 28. The steam source 48 may be a carpet cleaner or other steam generating apparatus.

A plurality of couplers 52 is provided and each of the couplers 52 is attached to the plate 12. Each of the couplers 52 engages the surface 28 such that the plate 12 is retained on the surface 28 and each of the couplers 52 is positioned proximate one of four corners 53 of the plate 12. Each of the couplers 52 comprises a cup 54 that has a top wall 56 and a perimeter wall 58 coupled to and extending away from the top wall 56. The top wall 56 has an outer surface 60 and an inner surface 62 and the cup 54 is attached to the bottom surface 16 of the plate 12 having the outer surface 60 abutting the bottom surface 16. The perimeter wall 58 of the cup 54 extends away from the bottom surface 16 of the plate 12 a distance that is greater than a distance that the peripheral wall 18 of the plate 12 extends beyond the bottom surface 16. The perimeter wall 58 of the cup 54 has an exposed edge 64 and the exposed edge 64 may abut the surface 28 such that the distal edge 22 is spaced away from the surface 28 thereby allowing the steam 50 to escape from the steam space 20.

A magnet 66 is provided that has an upper surface 68, a lower surface 70 and a peripheral edge 72 extending between the upper surface 68 and the lower surface 70. The magnet 66 is positioned within the cup 54 such that the upper surface 68 of the magnet 66 abuts the inner surface 62 of the top wall 56. The lower surface 70 lies on a plane that is planar with the exposed edge 64 thereby facilitating the lower surface 70 to magnetically engage the surface 28 thusly retaining the plate 12 on the surface 28. A fastener 74 extends through the magnet 66 and engages the plate 12 to retain the magnet 66 and the cup 54 on the plate 12. The fastener 74 may be a screw or the like.

In use, the plate 12 is positioned on the surface 28 so the steam space 20 surrounds the decal 30 and the magnet 66 in each of the couplers 52 magnetically engages the surface 28. The nozzle 44 is fluidly coupled to the steam source 48 so the steam 50 is directed onto the decal 30. The steam 50 breaks down the bond between the decal 30 and the surface 28, thereby facilitating the decal 30 to be removed from the surface 28. The steam 50 is directed onto the decal 30 for a sufficient amount of time to allow the decal 30 to be removed without leaving behind any residue on the surface 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A decal removal assembly configured to use steam to remove a decal from a surface, said assembly comprising:
a plate being structured to have a steam space extending therein, said plate being configured to be positioned proximate a surface such that said steam space surrounds a decal adhered to the surface, said plate having a bottom surface and a peripheral wall;
a handle being attached to said plate, said handle being in fluid communication with said steam space;
a nozzle attached to said handle, said nozzle having a distal end with respect to said handle, said nozzle being in fluid communication with said steam space, said distal end being configured to be fluidly coupled to a steam source such that steam from the steam source is directed into said steam space thereby facilitating removal of the decal from the surface;
a plurality of couplers, each of said couplers being attached to said plate, each of said couplers engaging the surface such that said plate is retained on the surface, each of said couplers being positioned proximate one of four corners of said plate, each of said couplers comprises a cup having a top wall and a perimeter wall coupled to and extending away from said top wall, said top wall having an outer surface and an inner surface, said cup being attached to said bottom surface of said plate having said outer surface abutting said bottom surface, wherein said perimeter wall extends away from said bottom surface of said plate a distance being greater than a distance that said peripheral wall of said plate extends beyond said bottom surface, said perimeter wall of said cup having an exposed edge, said exposed edge being configured to abut the surface such that said distal edge is spaced away from the surface thereby allowing the steam to escape from said steam space; and
a magnet having an upper surface, a lower surface and a peripheral edge extending between said upper surface and said lower surface, said magnet being positioned within said cup such that said upper surface of said magnet abuts said inner surface of said top wall, said lower surface lying on a plane being planar with said exposed edge, said lower surface being configured to magnetically engage the surface thereby retaining said plate on the surface.

2. The assembly according to claim 1, wherein said plate has a top surface, a bottom surface and a peripheral wall extending around said plate, said peripheral wall extending outwardly beyond said bottom surface to define a steam space, said peripheral wall having a distal edge with respect to said bottom surface, said plate having an opening extending through said top surface and said bottom surface, said peripheral wall having a first side, said opening being positioned proximate said first side, said distal edge being configured to be positioned proximate the surface such that said steam space surrounds a decal adhered to the surface.

3. The assembly according to claim 2, wherein said handle has a first end and a second end, said handle having a first bend positioned adjacent to said first end such that said first end is directed downwardly from a body of said handle, said handle having a second bend positioned adjacent to said second end such that said second end is directed downwardly from said body of said handle, said first end being open, said handle being substantially hollow, each of said first end and said second end being attached to said top surface, said first end being aligned with said opening in said plate such that said handle is in fluid communication with said steam space.

4. (canceled)

5. (canceled)

6. (canceled)

7. The assembly according to claim 1, further comprising a fastener extending through said magnet and engaging said plate, said fastener retaining said magnet and said cup on said plate.

8. A decal removal assembly configured to use steam to remove a decal from a surface, said assembly comprising:
a plate having a top surface, a bottom surface and a peripheral wall extending around said plate, said peripheral wall extending outwardly beyond said bottom surface to define a steam space, said peripheral wall having a distal edge with respect to said bottom surface, said plate having an opening extending through said top surface and said bottom surface, said peripheral wall having a first side, said opening being positioned proximate said first side, said distal edge being configured to be positioned proximate a surface such that said steam space surrounds a decal adhered to the surface;
a handle being attached to said plate, said handle having a first end and a second end, said handle having a first bend positioned adjacent to said first end such that said first end is directed downwardly from a body of said handle, said handle having a second bend positioned adjacent to said second end such that said second end is directed downwardly from said body of said handle, said first end being open, said handle being substantially hollow, each of said first end and said second end being attached to said top surface, said first end being aligned with said opening in said plate such that said handle is in fluid communication with said steam space;
a nozzle attached to said handle, said nozzle having a distal end with respect to said handle, said nozzle being in fluid communication with said steam space, said distal end being configured to be fluidly coupled to a steam source such that steam from the steam source is directed into said steam space thereby facilitating removal of the decal from the surface; and
a plurality of couplers, each of said couplers being attached to said plate, each of said couplers engaging the surface such that said plate is retained on the surface, each of said couplers being positioned proximate one of four corners of said plate, each of said couplers comprising
a cup having a top wall and a perimeter wall coupled to and extending away from said top wall, said top wall having an outer surface and an inner surface, said cup being attached to said bottom surface of said plate having said outer surface abutting said bottom surface, said perimeter wall extending away from said bottom surface of said plate a distance being greater than a distance that said peripheral wall of said plate extends beyond said bottom surface, said perimeter wall of said cup having an exposed edge, said exposed edge being configured to abut the surface such that said distal edge is spaced away from the surface thereby allowing the steam to escape from said steam space,
a magnet having an upper surface, a lower surface and a peripheral edge extending between said upper surface and said lower surface, said magnet being positioned within said cup such that said upper surface of said magnet abuts said inner surface of said top wall, said lower surface lying on a plane being planar with said exposed edge, said lower surface being configured to magnetically engage the surface thereby retaining said plate on the surface, and
a fastener extending through said magnet and engaging said plate, said fastener retaining said magnet and said cup on said plate.
